(19) United States
(12) Patent Application Publication
(10) Pub. No.: US 2008/0314414 A1
(43) Pub. Date: Dec. 25, 2008

(54) DISHWASHER WITH WATER REPLACEMENT

(76) Inventor: Karl HILDENBRAND, Oberkirch (DE)

Correspondence Address: Muncy, Geissler, Olds & Lowe, PLLC, P.O. BOX 1364, FAIRFAX, VA, 22038-1364, US

(21) Appl. No.: 12/131,350

(22) Filed: Jun. 2, 2008

Related U.S. Application Data
(60) Provisional application No. 60/944,784, filed on Jun. 18, 2007.

(30) Foreign Application Priority Data
May 31, 2007 (DE) 10 2007 025 434.4

(51) Int. Cl. B08B 3/04; A47L 15/42

(52) U.S. Cl. 134/25.2; 134/105

(57) ABSTRACT

A method for operating a commercial dishwasher is provided. The dishwasher comprises a washing chamber with a wash tank and is designed to wash items which are to be washed and are located in the washing chamber in a wash process with circulation operation. The dishwasher also has a final-washing tank and is designed to subject items which are to be washed and are located in the washing chamber to a final-washing step. The method comprises at least one program cycle with a wash process and a final-washing process and also the following steps: a) the final-washing tank is at least partially filled with water; b) the water in the final-washing tank is heated; and/or c) the heated water is transferred to the wash tank.

This nonprovisional application claims priority to German Patent Application No. 10 2007 025 434.4, which was filed in Germany on May 31, 2007, and to U.S. Provisional Application No. 60/944,784, which was filed on Jun. 18, 2007, and which are both herein incorporated by reference.

### FIELD OF THE INVENTION

The invention relates to a method for operating a commercial dishwasher. The invention also relates to a dishwasher for commercial use which, in particular, can be designed to carry out the method according to the invention in one of its embodiments.

### DESCRIPTION OF THE BACKGROUND ART

The conventional art discloses a wide variety of embodiments of dishwashers for cleaning an extremely wide variety of items to be washed. In this case, the term “items to be washed” is to be understood in the text which follows essentially as utensils which come into direct or indirect contact with food, for example plates, flatware, cups, trays, glasses, bowls, pots and pans or the like. However, as an alternative or in addition, the term “items to be washed” can also include other types of items to be washed, for example items to be washed from the field of chemical engineering, mechanical engineering or the like.

Dishwashers for commercial use and dishwashers for domestic use are known and are commercially available in a various embodiments. These two types of dishwashers are distinguished essentially in that, in contrast to domestic appliances, commercial dishwashers are optimized for a high throughput. Whereas domestic dishwashers operate, for this purpose, substantially with a single tank which is connected to a washing chamber and is used in succession for the individual washing steps, this principle generally cannot be used for commercial dishwashers on account of the large amount of time required for the respective filling and heating operations.

Commercial dishwashers therefore generally have at least two tanks, so that in particular the time-consuming heating steps can be carried out in parallel. Therefore, commercial dishwashers, for example, comprise at least one tank which is connected to the washing chamber and additionally at least one final-washing tank which is generally in the form of a boiler. As an alternative, a continuous-flow heater can also be used. Commercial dishwashers are known from the prior art in the form of pass-through dishwashers (for example in the form of belt-conveyor or rack-conveyor dishwashers) or as single-chamber dishwashers with a single chamber for accommodating the items to be washed. The following invention relates substantially to single-chamber dishwashers.

However, the above-described known single-chamber dishwashers still have the disadvantage that a comparatively long period of time is required in these dishwashers in order to bring the dishwasher to a state in which it is ready for operation after being switched on. This is caused, in particular, by the tank which is connected to the washing chamber and has a comparatively large volume (for example approximately 11 liters to 100 liters) requiring a considerable amount of time (for example approximately 10 minutes to approximately 40 minutes) until it is heated to a temperature of, for example, 60° C., as is required for a wash process.

A further disadvantage of customary single-chamber dishwashers is that the final-washing tank usually has a comparatively small volume in order to save energy costs and to protect the environment. However, this means that a final-washing process which follows the wash process, which is usually carried out with circulation operation, is very limited in terms of duration and intensity. Typical quantities of final-washing water are 2-3 liters, and this also severely limits the entire quantity of heat introduced during the final-washing process and therefore the hygiene effect of the final-washing process at customary final-washing temperatures of 83° C. (for dishes) and 65° C. (for glasses).

### SUMMARY OF THE INVENTION

It is therefore an object of the present invention to provide a method for operating a dishwasher which reduces the period of time required to establish readiness for operation and which improves utilization of resources which are available in customary commercial dishwashers.

An embodiment of the present invention provides to optimize the resources available in customary dishwashers and to reduce the period of time required until readiness for operation is established, by using a method with intelligent water replacement between washing and final-washing. This water replacement can be used to prepare for one or more wash processes, to prepare for one or more final-washing processes or to prepare for a wash and final-washing process.

The proposed method uses a commercial dishwasher according to the above description which comprises a washing chamber with a wash tank which is connected to the washing chamber. According to the above definition, said dishwasher is therefore a single-chamber dishwasher, that is to say a dishwasher which has one single washing chamber, but which can of course also be divided into subregions. The dishwasher is designed to wash items which are to be washed and are located in the washing chamber in a wash process with circulation operation. The dishwasher also has a final-washing tank which can, for example, be designed as a boiler, but with the use of final-washing tanks with continuous-flow heaters also being possible. The dishwasher is designed to subject items which are to be washed and are located in the washing chamber to a final-washing step.

The invention proposes the following method using a dishwasher of this type, with the individual method steps being described in greater detail in the text which follows. The steps are not necessarily carried out in the described order. Furthermore, the described method can also include additional steps which are not mentioned, and individual method steps or a plurality of method steps can be carried out in parallel or repeatedly.

In a first method step, the final-washing tank is at least partially filled with water. This water is heated in the final-washing tank, it being possible to use, for example, the boiler heating means for this purpose. The heated water is then transferred to the wash tank.

An existing final-washing nozzle system, which is usually used for the final-washing step, can, for example, be used for this transfer of the water to the wash tank. It is preferred, however, to use a dishwasher which has a connection line between the final-washing tank and the wash tank, so that heated water can be transferred directly from the final-washing tank to the wash tank. This connection line can comprise, for example, one or more valves by means of which the transfer of the heated water from the final-washing tank to the wash tank can be controlled. Furthermore, one or more pumps can be provided for this transfer operation.

The described steps of filling the final-washing tank, heating the water in the final-washing tank and transferring the heated water to the wash tank can preferably be carried out repeatedly until the wash tank has reached, for example, a predefined filling level. In this way, the wash tank can be rapidly filled with heated water, in order to then be able to carry out a wash process or a final-washing process, on account of the water replacement using the comparatively low volume of the final-washing tank, in particular of the boiler.

The method also comprises carrying out one or more wash processes and carrying out one or more final-washing processes. Depending on the refinement of the method, the above-described filling of the wash tank from the final-washing tank, which is called “water replacement” here and in the text which follows, can be used for the wash process or the final-washing process. Wash processes and/or final-washing processes can be carried out with single operation or with circulation operation, it being possible to use a circulation pump for this purpose.

The method in which the described water replacement is carried out before at least one of the program steps “wash process” and “final-washing process” permits readiness for operation to be established more quickly and permits a large number of time- and energy-saving options compared to customary conventional dishwashers in which a strict distinction is made between the wash system and the final-washing system. Therefore, resources and advantages of the wash system, for example the usually large tank volume of the wash tank and the option of circulation operation, can also be used for the final-washing process, while resources and advantages of the final-washing system, such as, in particular, the rapid and efficient heating of water in a boiler, can also be used for the wash process.

The described method of water replacement, in which water is successively transferred from the final-washing tank to the wash tank in order to fill said tank to prepare for a wash process or final-washing process, has the considerable advantage over known methods that readiness for operation can be established considerably more quickly. If a wash tank heating means is additionally provided, the wash tank heating means and the final-washing tank heating means can operate in parallel, so that the required quantity of water can be rapidly provided by separate systems. However, as an alternative, a wash tank heating system can also be completely dispensed with.

As described above, the steps of filling the final-washing tank, heating in the final-washing tank and transferring the heated water to the wash tank can be carried out repeatedly, for example until the wash tank has reached a predefined minimum level for the wash process and/or final-washing process. A pressure-increasing pump can be used for the transfer operation.

In a further advantageous refinement, the final-washing liquid remains in the wash tank after the end of the final-washing step. This final-washing liquid, which, as described above, is usually at a higher temperature than that for the wash process, is usually only contaminated to a minor extent. Furthermore, this final-washing liquid is usually only water to which, for example, a rinsing liquid (for example specific surfactants) can additionally be added. This final-washing liquid is also suitable for a wash process. Establishment of readiness for operation can additionally be accelerated in this way since the excess quantity of heat in this remaining final-washing liquid can be used in a subsequent next program cycle in order to provide the required quantity of heat in the wash tank for a wash process more rapidly.

It is therefore possible, for example, for a second program cycle comprising the described steps to follow a first program cycle comprising the above-described steps, with the heated water from the final-washing tank being mixed with the final-washing liquid remaining in the wash tank from the first program cycle during the iterative filling of the wash tank by means of the final-washing tank. This ensures that a waiting time between the individual programs cycles can be considerably reduced.

The water in the final-washing tank can be heated to prepare for the wash process, that is to say the wash water can be provided, in such a way that the heated water in the final-washing tank is at an excess temperature above the wash temperature when it is transferred to the wash tank. This excess temperature can be selected, in particular, in such a way that customary heat losses which occur when the heated water is transferred to the wash tank and heat losses which occur due to contact with the (usually colder) washing chamber, wash tank walls and/or items to be washed in the washing chamber are compensated for. This excess temperature can be selected in such a way that the predefined wash temperature is at least approximately maintained (that is to say, for example, kept within predefined limits, for example +/−5° C.) during the subsequent wash process. The excess temperature can, for example, be based on empirical values which can be stored, for example, in a data memory. However, as an alternative or in addition, analytical or semi-empirical methods can also be used, which methods calculate or determine customary heat losses on the basis of loading of the washing chamber with items to be washed, for example.

However, a pump-action extraction step, in which the water from the wash tank is fully drained or pumped out after the end of final-washing step, can additionally be provided, particularly when provision is made for the final-washing water to remain in the wash cycle after the final-washing step. By way of example, this pump-action extraction step can be initiated, for example, by a user operating a “Last program sequence” key or an “Empty” key in order to indicate that the dishwasher should be switched off.

As described above, the method can be carried out in such a way that a plurality of program cycles comprising the described method steps are carried out. Additionally, method steps which have not yet been mentioned can also be carried out. In this case, a standby step can be carried out particularly between and/or before at least one of said program cycles, in which standby step only the method steps of filling the final-washing tank, heating the water in the final-washing tank and transferring water to the wash tank are carried out, in order to establish readiness for operation with the subsequent program cycle. By virtue of this standby step, readiness for operation for a subsequent wash process can be maintained, so that a wash process can be carried out immediately following the standby step. The standby step, which is followed by a time delay until the subsequent wash process, can therefore form a constituent part of a subsequent program cycle in which only the steps of washing, the steps of heating the final-washing water in the final-washing tank (but this can likewise already be a constituent part of the standby step) and the final-washing step are then carried out.

In accordance with the above-described method, the wash tank is preferably iteratively filled with water via the final-washing cycle or boiler in order to establish readiness for operation and prepare for the wash process. However, the wash tank can also additionally have a direct inlet via which said wash tank can be at least partially filled with (fresh) water, so that filling of the wash tank via the final-washing tank can be assisted. Filling of the wash tank and preparation for the wash process can be additionally accelerated in this way. The wash tank can have, in particular, a wash tank heating means which likewise assists preparation for the wash process and therefore accelerates establishment of readiness for operation. The excess temperature in the final-washing tank can be of such a magnitude (for example can be calculated or empirically determined) that it also compensates for heat losses which occur when cold water, which is supplied to the wash tank directly via the direct inlet, is admixed.

Furthermore, a cleaning fluid, in particular a dishwashing detergent, can additionally be added to the wash tank before the wash process is carried out. Cleaning fluids or dishwashing detergents of this type, which can, in particular, contain wash-active substances and/or bleaching agents, are known from the prior art. In addition, a rinse aid can also be added to the final-washing tank before the final-washing step is carried out, in order to improve the cleaning effect in the final-washing step and to increase the degree to which the items being washed are free from spotting.

As described above, the final-washing step can be performed directly by water from the final-washing tank acting on the items being washed. As described in the introduction, the volume of the final-washing tank (in particular of a boiler) is however very limited, usually to 2 to 3 liters of usable water. This limited quantity of water or quantity of heat therefore also restricts the cleaning effect or the hygiene effect of the final-washing step.

A circulation method is therefore also used in the final-washing step in a further preferred method variant, which is preferably carried out in combination with the above-described filling of the wash tank for the wash process via the final-washing tank, but which can also be used independently of the above-described method. In this circulation method, the wash tank is filled with heated water from the final-washing tank by way of example (but not necessarily) after the end of the wash process (and draining or pump-action extraction of the wash water). The described water replacement for preparing for the final-washing step is therefore carried out here. The final-washing step is then carried out, preferably with circulation operation, with the final-washing water which is located in the wash tank.

In this embodiment, a rinse aid can additionally be added to the final-washing water which is located in the wash tank before the final-washing step is carried out. The rinse aid can be added to the final-washing tank or, as an alternative or in addition, to the wash tank. The latter alternative has the particular advantage that contamination of the final-washing tank with rinse aid can be avoided.

Operation of the final-washing process with final-washing liquid from the wash tank (which should be full in this case) permits a final-washing process with a low quantity of water which, however, can be used several times, so that the introduction of heat to the items being washed in the final-washing process and therefore the hygiene effect are increased overall. Preferred water temperatures in the wash process are between 50° C. and 60° C., preferably approximately 60° C. Preferred temperatures in the final-washing step are between 50° C. and 90° C., preferably 83° C., for dishes, or approximately 65° C. for glasses. The water temperatures can be influenced, for example, by a control means.

As described above, customary commercial dishwashers can be used for the proposed method, which dishwashers have a control means which is designed to be programmed, in order to carry out the method in one of the proposed variants.

However, irrespective of the presence of a control means of this type and irrespective of the described method being carried out, a dishwasher has proven advantageous which, in addition to the above-described features of the washing chamber, of the wash tank and of the final-washing tank, also comprises a connection line in order to transfer water directly from the final-washing tank to the wash tank. In this case, “directly” is to be understood to mean, in particular, bypassing a final-washing nozzle system.

If, as described above, the dishwasher has a control means which is designed to carry out a method in one of the described embodiments, the dishwasher can therefore be designed, in particular, to selectively carry out the final-washing step with water from the final-washing tank (conventional procedure) or, after filling from the final-washing tank, with water from the wash tank. The latter variant has the above-described advantages, so that, for example, the final-washing step can be performed with circulation operation.

As described above, the dishwasher can additionally have a fresh water inlet in order to at least partially fill the wash tank directly, bypassing the final-washing tank. This variant is positively distinguished particularly by simultaneous heating of wash water for the wash process in the wash chamber and in the final-washing tank.

The dishwasher can also have a separate wash nozzle system and a final-washing nozzle system. As an alternative, the same nozzle systems could also be used for the wash process and the final-washing step, but this is less preferred for hygiene reasons.

Furthermore, the scope of the invention includes a computer program which executes the method according to the invention in one of its refinements when said program is run on a computer or computer network. The scope of the invention also includes a computer program with program code means, in order to carry out the method according to the invention in one of its refinements when the program is run on a computer or computer network. In particular, the program code means can be stored on a computer-readable data storage medium. The scope of the invention also includes a data storage medium in which a data structure is stored which can execute the method according to the invention in one of its refinements after being loaded into a working and/or main memory of a computer or computer network. The scope of the invention also includes a computer program product with program code means stored on a computer-readable storage medium, in order to carry out the method according to the invention in one of its refinements when the program is run on a computer or computer network. In this case, a computer program product is understood to be the program in the form of a saleable product. In principle, it can be present in any desired form, for example as a hard copy or a computer-readable data storage medium and can be distributed, in particular, via a data transmission network. The scope of the invention finally includes a modulated data signal which contains instructions, which can be executed by a computer system or computer network, for executing a method according to one of the described method variants.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary embodiment of a dishwasher according to the invention;

FIG. 2 shows a first exemplary embodiment of the method according to the invention with iterative filling of the wash tank via the final-washing tank before the wash process;

FIG. 3 shows a second exemplary embodiment of the method according to the invention as per FIG. 2 with a standby mode;

FIG. 4 shows a variant of the method illustrated in FIG. 3 with an optional pump-action extraction process;

FIG. 5 shows a variant of the method illustrated in FIG. 3 with an automatic pump-action extraction step;

FIG. 6 shows a variant of the method illustrated in FIG. 2, with the wash tank additionally being used for the final-washing step;

FIG. 7 shows a method variant in which the wash tank, which is iteratively filled via the final-washing tank, is used for the final-washing operation; and

FIG. 8 shows a variant of the method illustrated in FIG. 7 with an additional pump-action step which is initiated by the user.

### DETAILED DESCRIPTION

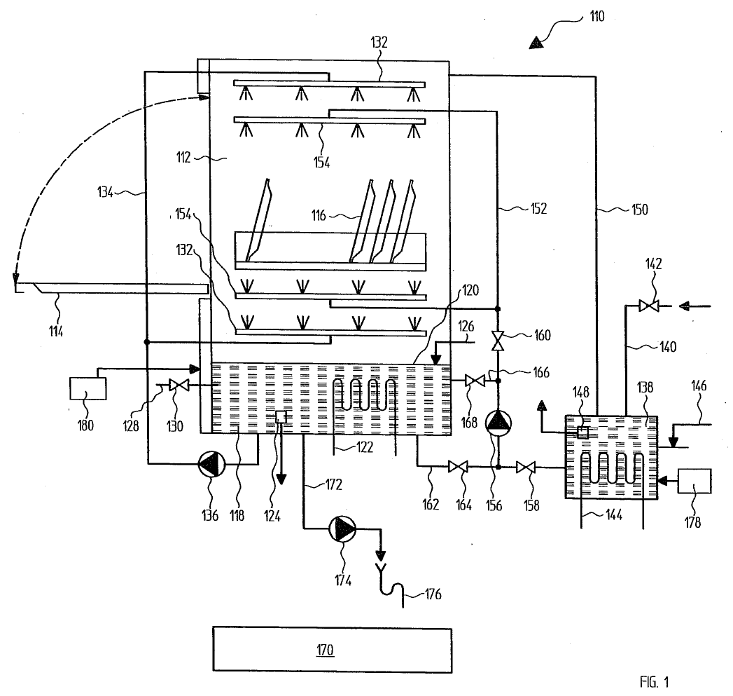

FIG. 1 illustrates a dishwasher 110 for commercial use which can be used according to the invention. The dishwasher has a washing chamber 112 which, in this case, is designed as a front-loader and is opened via a front flap 114. Items 116 to be washed are placed in the washing chamber 112.

In its lower region, the washing chamber has a wash tank 118 which, in this exemplary embodiment, is separated from the rest of the washing chamber 112 by a perforated plate 120. In this exemplary embodiment, the wash tank 118 has a wash tank heating means 122 which is only symbolically indicated in FIG. 1. The wash tank 118 also has a temperature sensor 124, a level sensor 126 and a fresh water inlet 128 with a valve 130.

The washing chamber 112 contains a wash nozzle system 132 which has spray arms and is connected to the wash tank 118 via a wash line system 134 and a circulation pump 136. In this way, the items 116 to be washed can be washed in a wash process with circulation operation. However, as an alternative, a system with fixed nozzles could be used instead of the spray arms.

The dishwasher 110 according to the exemplary embodiment in FIG. 1 also has a final-washing tank 138 which, in this exemplary embodiment, is designed as a boiler. This final-washing tank can be filled with fresh water via an inlet 140, with the inlet 140 having a valve 142. In the final-washing tank 138, the water can be heated by a final-washing tank heating means 144. The final-washing tank 138 likewise has a level sensor 146 and a temperature sensor 148.

The final-washing tank 138 is connected to the washing chamber 112 via an excess-pressure line 150 which, for example, makes it possible for steam to escape from the final-washing tank 138 into the washing chamber 112. This excess-pressure line 150 constitutes a safety feature.

The final-washing tank 138 is also connected to a final-washing nozzle system 154 via a final-washing line system 152. A final-washing process can be carried out by means of this final-washing nozzle system 154. To this end, the final-washing line system 152 also contains a pressure-increasing pump 156 and two valves 158 and 160. In this case, a first valve 158 is held between the final-washing tank 138 and the pressure-increasing pump 156 in the final-washing line system 152, and a second valve 160 is held in the final-washing line system 152 downstream of the pressure-increasing pump 156 and upstream of branches to the final-washing nozzle system 154.

In this exemplary embodiment, the final-washing line system 152 is additionally connected to the wash tank 118 at two points. A connection line 162 which leads to the wash tank 118 therefore issues between the first valve 158 and the pressure-increasing pump 156 in the final-washing line system 152. This connection line 162 likewise has a valve 164.

A further connection is established by a filling line 166 which contains a filling valve 168 and issues between the pressure-increasing pump 156 and the valve 160 in the final-washing line system 152.

The dishwasher 110 according to the exemplary embodiment in FIG. 1 also has a control means 170 which is only symbolically indicated in FIG. 1. This control means can comprise electronic components and can additionally comprise, for example, a computer system which is designed to be programmed in order to carry out a method in one of the embodiments described above and in the text which follows. This control means 170 can be connected, for example, to the temperature sensors 124, 148 and to the level sensors 126, 146 and also to the control means with the various valves 130, 158, 160, 164, 168, 142. It should also be possible to actuate the pumps 136, 156 using the control means 170.

The dishwasher in the exemplary embodiment in FIG. 1 also has an discharge line 172 with an discharge pump 174 by means of which (for example likewise in a manner controlled by the control means 170) water can be pumped out of the wash tank 118 into a discharge 176.

Furthermore, various metering systems 178, 180 are provided in the exemplary embodiment according to FIG. 1, which metering systems can, in turn, likewise be controlled by the control means 170 and by means of which rinse aid can be added, for example, in the final-washing tank 138, and a dishwashing detergent or a rinse aid can selectively be added to the wash tank 118, depending on the type of method used (see below).

By way of example, a method according to the invention can be implemented with the dishwasher 110 illustrated in FIG. 1. Exemplary embodiments of this method are illustrated in the following figures. All these exemplary embodiments share the common feature that the wash tank is filled via the final-washing tank, with the final-washing tank initially being at least partially filled with water, this water being heated there and the heated water then being transferred to the wash tank. These steps can be carried out iteratively. The individual methods differ by virtue of the time at which the wash tank is filled by the final-washing tank, and the purpose of this filling. Therefore, in some methods, the wash process is prepared for in this way, whereas in other methods the final-washing process is prepared for in this way.

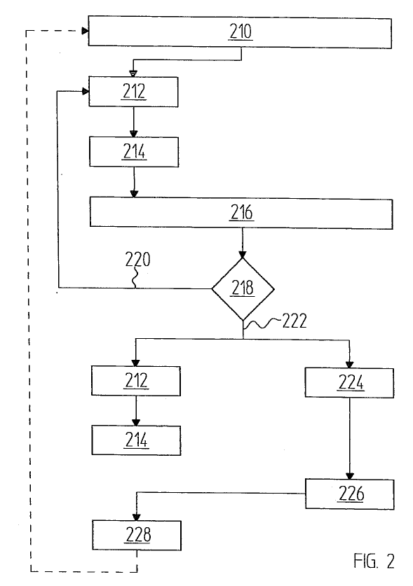

FIG. 2 illustrates a first method variant in which filling of the wash tank 118 via the final-washing tank 138 is used to prepare for a wash process.

After the dishwasher 110 is started (step 210), the readiness of the dishwasher 110 for operation is first established. To this end, the final-washing tank 138 is filled with fresh water in step 212, and this filling can be performed via the inlet 140, for example by the control means 170 opening the valve 142.

The water in the final-washing tank 138 is then heated in step 214. This can be done by the control means 170 correspondingly actuating or heating the final-washing tank heating means 144.

The water is then transferred from the final-washing tank 138 to the wash tank 118 in method step 216. In the exemplary embodiment of the dishwasher 110 according to FIG. 1, this can be done by the valves 158 and 168 being opened while the valves 160 and 164 are closed, with the pressure-increasing pump 156 transferring the water from the final-washing tank 138 to the wash tank 118.

A check is then made in method step 218 to determine whether a specific, predefined level is reached in the wash tank 118, for example whether the wash tank 118 is filled. This can be done, in particular, by the control means 170 checking the level sensor 126.

If the desired level is not reached (branch 220 in FIG. 2), method steps 212, 214 and 216 are repeated. If, in contrast, the desired level is reached (branch 222 in FIG. 2), a wash process 224 is started. In the exemplary embodiment of the dishwasher 110 according to FIG. 1, this can be done, for example, by the valves 164 and 168 being closed and by the circulation pump 136 being started. In this way, the items 116 to be washed are washed in the washing chamber 112 with circulation operation.

In the method sequence illustrated in FIG. 2, the final-washing tank 138 is refilled (step 212) and the water in the final-washing tank 138 is heated (step 214) in parallel with the wash process 224 (that is to say preferably simultaneously, but with a time offset also being tolerated). The subsequent final-washing process (see below) is prepared for in this way.

After the end of the wash process 224, the wash water is pumped out of the wash tank 118 (step 226). This can be done, for example, by the discharge pump 174 being started in FIG. 1.

After the end of the pump-action extraction operation, a final-washing process 228 is then started. In FIG. 1, this can be done by the valves 164, 168 being closed, the valves 158 and 160 being opened and the pressure-increasing pump 156 being started. In this way, the items 116 to be washed are acted on by the water located in the final-washing tank 138, possibly with the addition of rinse aid by the metering system 178.

After the end of the final-washing process 228, the cycle can return to the start 210.

In the exemplary embodiment in FIG. 2, the first method steps, that is to say method steps 210 to 218, serve to establish readiness for operation. The following method steps including the wash process 224 to the final-washing process 228 constitute the actual program sequence. All the steps together form a program cycle. This program cycle can be carried out repeatedly.

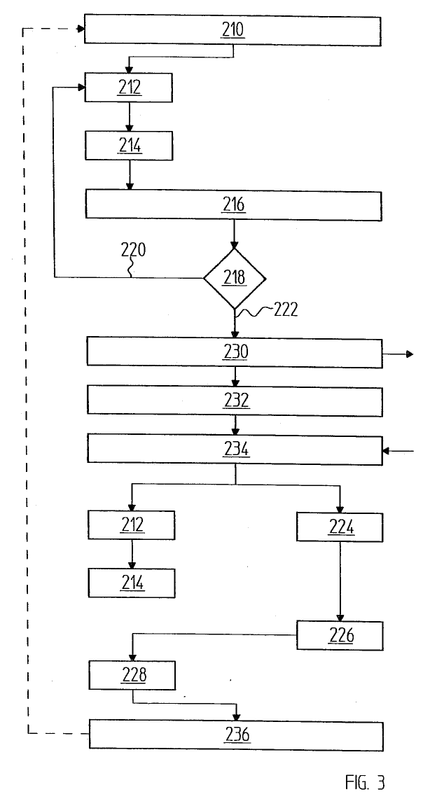

FIG. 3 shows a variant of the method illustrated in FIG. 2, in which variant the separation between establishment of readiness for operation and the actual program sequence including the wash process and the final-washing process is more greatly pronounced. In this case, method steps 210 to 222 are again initially carried out, in which method steps, as described above with reference to FIG. 2, readiness for operation is established by heated wash water being introduced into the wash tank 118 by iterative filling of the wash tank 118 via the final-washing tank 138. If readiness for operation is established, the readiness for operation is indicated in step 230. This can be done, for example, by setting a control bit in the control means 170, and/or audible or visual signals can be relayed to a user.

This establishment of readiness for operation is optionally followed by a waiting time (standby phase 232). The preceding method steps 210 to 230 may also be constituent parts of this standby phase, that is to say a phase in which neither a wash process nor a final-washing process is carried out.

If the actual program sequence is then started (step 234 in FIG. 3), for example by a user operating a program start key, the wash process 224 is again started analogously to FIG. 2 and, parallel to this, the final-washing tank 138 is again filled (step 212) and the water located in the final-washing tank 138 is heated (step 214). However, steps 212 and 214 can optionally be carried out as early as in the standby phase 232.

Following the wash process 224, the water is again, analogously to FIG. 2, pumped out of the wash tank 118 (step 226) and the final-washing process 228 is carried out. However, in contrast to FIG. 2, the final-washing water remains in the wash tank 118 after the end of the final-washing process 228 (denoted by reference numeral 236 in FIG. 3) in the exemplary embodiment in FIG. 3. When the program is restarted 210, this final-washing water in the wash tank 118 is mixed, in step 216, with water which is freshly added and heated in the final-washing tank 138 in step 214, so that readiness for operation is established more quickly (step 230).

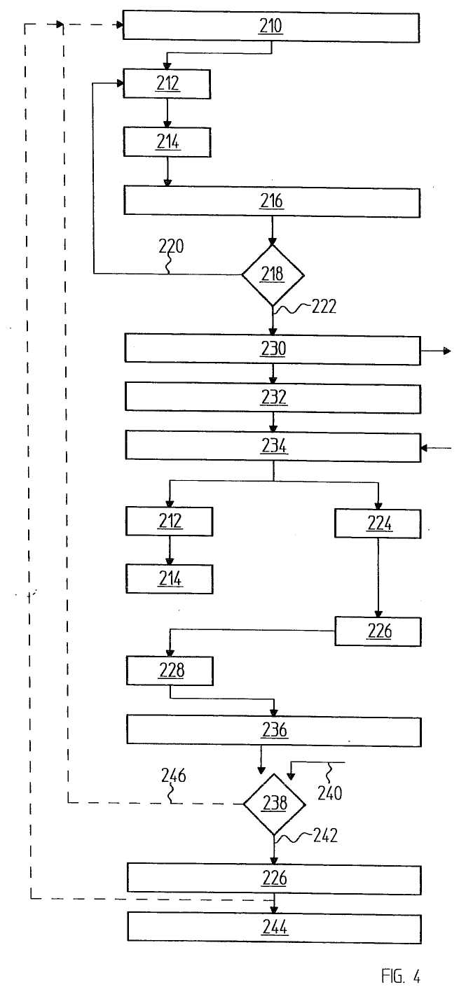

FIG. 4 shows a modification to the method illustrated in FIG. 3. This method differs from the method illustrated in FIG. 3 only by virtue of the concluding phase of the program sequence. As in FIG. 3, the final-washing water remains in the wash tank 118 (step 236), after the final-washing process 228 is carried out, in FIG. 4 too. However, in this case, a check 238 is carried out in which it is checked whether a user has pressed a pump-action extraction key or not (symbolically denoted by reference numeral 240 in FIG. 4). If this pump-action extraction key is pressed (branch 242), water is pumped out of the wash tank 118 (step 226). The program can then be terminated (step 244) or it can return to the start 210 again. If the pump-action extraction key is not pressed (branch 246), the program can, for example, immediately return to the start 210, so that the final-washing water remaining in the wash tank 118 can then be reused in a new program cycle, analogously to FIG. 3.

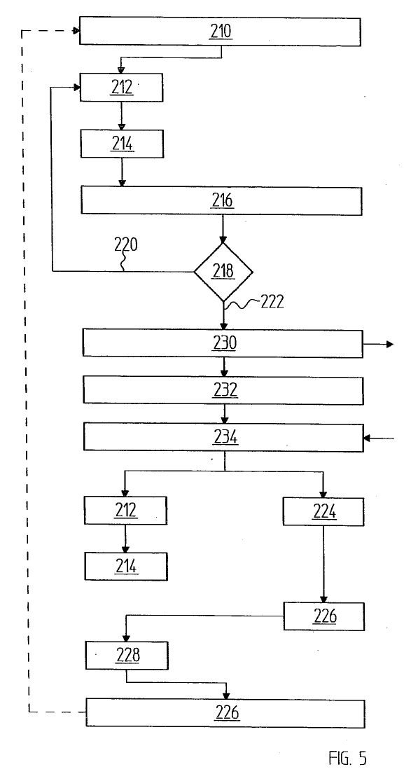

FIG. 5 shows a further modification to the method illustrated in FIG. 3. This method corresponds substantially to the method according to FIG. 3, with the exception that in the concluding part, after the end of the final-washing process 228, water is automatically pumped out in step 226, after which the program can return to the start in step 210. Otherwise, the method corresponds to the method in FIG. 3.

In the methods illustrated up until this point in FIGS. 2 to 5, the iterative filling of the wash tank 118 by the final-washing tank 138 was used only to prepare for the wash process 224. The final-washing process 228 was respectively carried out only with the water contained in the final-washing tank 138. In this case, the figures do not mention that detergent can be added to the wash tank 118 from the metering system 180 for the wash process 224, and that rinse aid can be added to the final-washing tank 138 from the metering system 178 for the final-washing process 228.

Iterative filling of the wash tank 118 from the final-washing tank 138 with water, which is heated there, for preparing for the wash process 224 can additionally be performed by introducing fresh water into the wash tank 118 through the fresh water inlet 128. To this end, it is possible, for example, in addition to the illustrated method step of transferring the water from the final-washing tank to the wash tank 216, for the control means 170 to respectively open the valve 130, so that a specific quantity of fresh water is fed to the wash tank 118 and there mixed with water from the final-washing tank 138 and, for example, heated by this or, as an alternative or in addition, can be heated by the (optional) wash tank heating means 122.

As an alternative or in addition to the iterative filling of the wash tank 118 from the final-washing tank 138 to prepare only for the wash process 224, this iterative filling of the wash tank 118 from the final-washing tank 138 can also be used to prepare for the final-washing process 228. In this case, the final-washing process is not limited by the limited volume of the final-washing tank 138, but it is possible, for example, for the wash tank 118, after it has been emptied, to be filled from the final-washing tank 138 for the final-washing process 228. The valves 164 and 160 are then opened, whereas the valves 158 and 168 are closed. By starting the pressure-increasing pump 156, the items 116 to be washed are then subjected to final-washing by means of the final-washing nozzle system 154 with circulation operation.

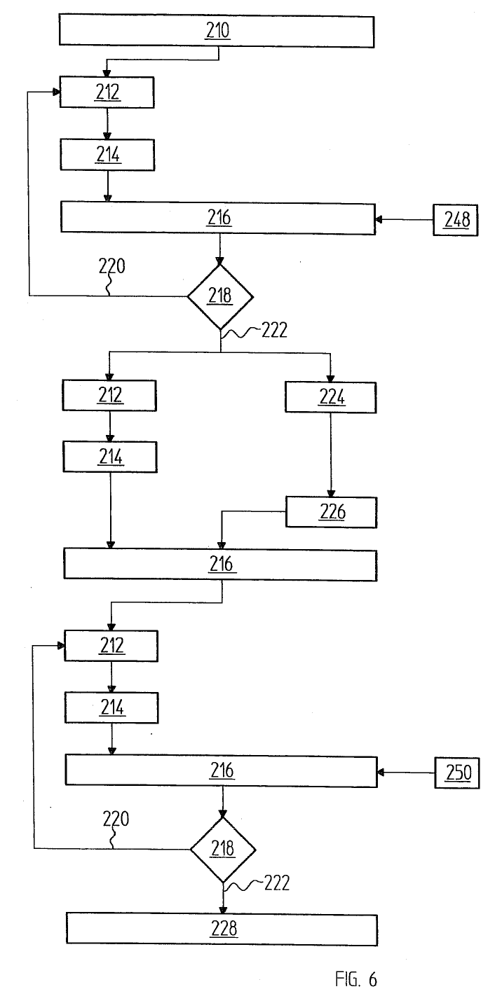

Examples of such methods, in which the iterative filling of the wash tank 118 from the final-washing tank 138 is used to prepare for the final-washing process 228, are illustrated in FIGS. 6 to 8.

In this case, FIG. 6 shows an exemplary embodiment in which the iterative filling of the wash tank 118 from the final-washing tank 138 is used both for the wash process 224 and for the final-washing process 228. After the start 210, the final-washing tank 138 is in this case initially filled with water again in step 212, this water is heated in step 214 and transferred to the wash tank in step 216. In this case, as indicated by reference numeral 248 in FIG. 6, detergent can additionally be added to the wash tank 118 via the metering system 180. The check, which is already known from the preceding methods, to determine whether the wash tank has reached a predefined filling level is again performed in step 218. If this is not the case (branch 220), method steps 212 to 216 are repeated, whereas, if this is the case (branch 222), firstly the wash process 224 is started and secondly the final-washing tank 138 is refilled (212) and the water in the final-washing tank 138 is heated (step 214) for the subsequent final-washing process. The wash process 224 is carried out at least until the water in the final-washing tank 138 has reached the temperature required for the final-washing process. After the end of the wash process 224, water is pumped out of the wash tank 118 by means of the discharge pump 178, in order to prepare said wash tank for the final-washing process.

The final-washing water from the final-washing tank 138 is then transferred to the wash tank 118 (step 216) by opening the valves 158 and 168 and operating the pressure-increasing pump 156. However, since the volume of the final-washing tank 138 is generally not sufficient for circulation operation from the wash tank 118, this transfer step 216 is again followed by filling of the final-washing tank (212) and heating of the water in the final-washing tank (step 214). This second quantity of water is then transferred (step 216) to the wash tank 118 again, it also being possible to add rinse aid (denoted by reference numeral 250 in FIG. 6). In this case, the rinse aid can be added to the final-washing tank 138 either from the metering system 178 or can be added directly to the wash tank 118, for example via the metering system 180 which therefore can also be designed as a multifunctional metering system.

A check is then made in step 218 to determine whether the wash tank 118 has already reached the predefined level for the final-washing process 228. If this is not the case (220), a quantity of water is again fed to the wash tank 118 by filling the final-washing tank (212), heating the water in the final-washing tank (214) and transferring said water to the wash tank 118. If the quantity of water required for the final-washing process 228 in the wash tank 118 is finally reached, the iterative filling of the wash tank 118 from the final-washing tank 138 is terminated (step 222) and the final-washing process is carried out (step 228).

After the final-washing process 228, the water can be either completely or partially pumped out of the wash tank 118, or all or some of said water can remain in the wash tank, for example as shown in step 236 in FIG. 3, for a wash process 224 of a subsequent program cycle.

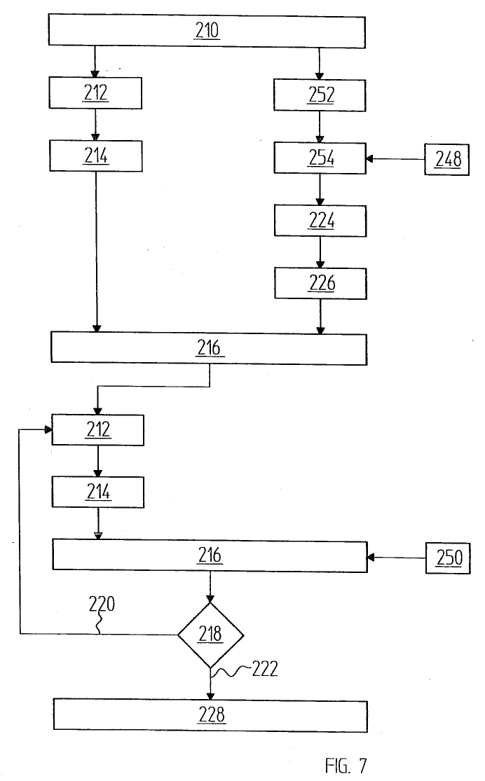

The method in FIG. 6 therefore shows an exemplary embodiment in which the iterative filling of the wash tank 118 via the final-washing tank 138 is used both for the wash process 224 and for the final-washing process 228. In contrast, FIG. 7 shows a modified exemplary embodiment in which the iterative filling is used exclusively for the final-washing process 228, with the final-washing process 228 therefore being performed with circulation operation from the wash tank 118 again.

In this case, after the program start 210, the final-washing tank 138 is initially again filled in step 212 and the water in the final-washing tank 138 is heated in step 214. However, this water is not transferred to the wash tank 118 immediately after being heated, but initially remains in the final-washing tank 138.

However, the wash tank 118 is filled via the fresh water inlet 128 (step 252) at the same time or with a time delay in relation to step 212, for which purpose, for example, the inlet valve 130 can be opened. This water is heated in step 254 by the control means 170 actuating the wash tank heating means 122. Detergent can be added to the wash tank 118 at the same time or in addition (step 248).

If the water in the wash tank 118 is at the temperature required for the wash process, the wash process 224 can be started. The water is pumped out of the wash tank 118 after the end of the wash process 224 (step 226).

After the pump-action extraction operation in step 226, the hot water is transferred from the final-washing tank 138 to the wash tank 118 in step 216, in order to prepare for the subsequent final-washing step. Since, however, the quantity of water from the final-washing tank 138 is generally not sufficient, as described above, this transfer operation 216 is followed by further iterative filling steps, that is to say a sequence of steps 212, 214 and 216. A check 218 to determine whether the water level in the wash tank 118 is sufficient can again be made at this or at other times. If this is not the case (branch 220), iterative filling is continued, whereas, when the water level is sufficient (branch 222), the final-washing process 228 can be started. Furthermore, for the final-washing process, rinse aid can be added to the final-washing tank 138 and/or to the wash tank 118 at any time after water is pumped out of the wash tank 118 after the end of the wash process 224, as is indicated by reference numeral 250 in FIG. 7.

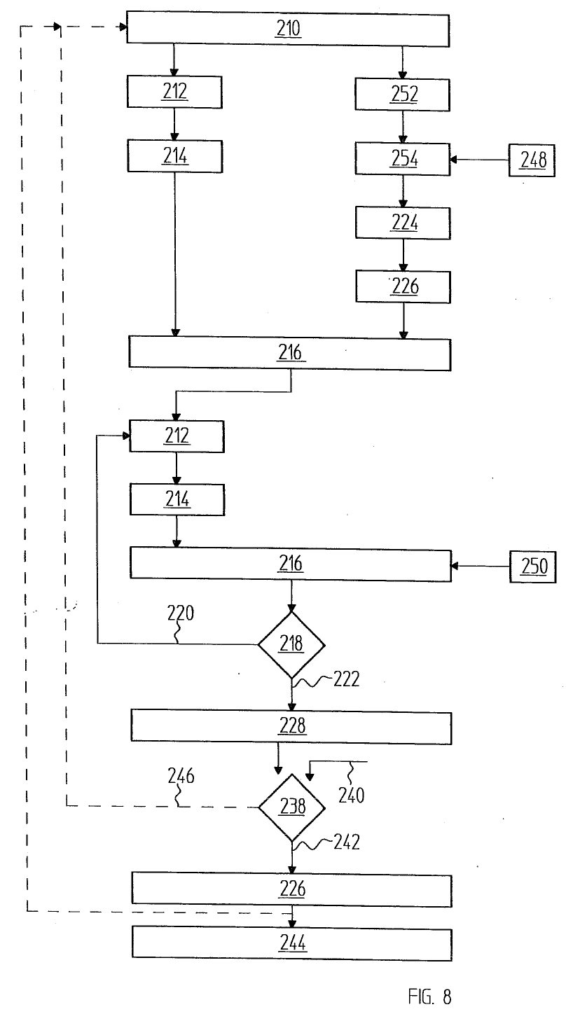

After the end of the final-washing process 228, the options, already mentioned above, of leaving all or some of the final-washing water in the wash tank 118, in order to be able to use it in a wash process 224 for a subsequent program cycle, or of pumping out this water are again available. This is illustrated in FIG. 8 which shows an alternative to FIG. 7.

The method illustrated in FIG. 8 initially runs in an identical manner to the method illustrated in FIG. 7. However, analogously to the exemplary embodiment in FIG. 4 above, the final-washing process 228 is followed by a check to determine whether the pump-action extraction key (indicated by reference numeral 240) is pressed or not (step 238). If the pump-action extraction key is pressed (step 242), water is pumped out in method step 226, after which operation can either be terminated (step 244) or can be restarted 210 with an empty wash tank 118. If, in contrast, the pump-action extraction key is not pressed (case 246 in FIG. 8), all or some of the final-washing water is left in the wash tank 118, without being pumped out, and the final-washing water can be used in a subsequent program cycle.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a commercial dishwasher having at least one program cycle with a wash process and a final-washing process, the dishwasher comprising a washing chamber with a wash tank and is designed to wash items, which are to be washed and are located in the washing chamber, in a wash process with a circulation operation, the dishwasher also comprising a final-washing tank and is designed to subject items, which are to be washed and are located in the washing chamber, to a final-washing step, wherein the method comprising:
a. partially filling the final-washing tank with water;
b. heating the water in the final-washing tank; and
c. transferring the heated water to the wash tank.

2. The method as claimed in claim 1, wherein the steps a), b) and c) are carried out repeatedly.

3. The method as claimed in the preceding claim, wherein the steps a), b) and c) are carried out until a water level in the wash tank reaches a predefined minimum level for the wash process and/or the final-washing step.

4. The method as claimed in claim 1, wherein a pressure-increasing pump is used in step c).

5. The method as claimed in claim 1, wherein the final-washing tank is at least partially filled with water, and this water is heated, while the wash process is being carried out.

6. The method as claimed in claim 1, wherein the final-washing liquid remains in the wash tank after the end of the final-washing process.

7. The method as claimed in claim 1, wherein a second program cycle is carried out after the first program cycle is carried out, wherein all or some of a final-washing liquid of a final-washing process of the first program cycle is used during the wash process of the second program cycle for the wash process.

8. The method as claimed in claim 7, wherein the heated water from the final-washing tank is mixed with the final-washing liquid remaining in the wash tank from the first program cycle in step c) of the second program cycle.

9. The method as claimed in claim 1, wherein the wash process and/or the final-washing process are/is carried out at a predefined temperature of the water, wherein the water is heated in the final-washing tank in method step b) in such a way that the heated water is at an excess temperature above the predefined temperature, in such a way that customary heat losses which occur when the heated water is transferred to the wash tank and heat losses which occur due to contact of the heated water with a customary quantity of items to be washed in the washing chamber are compensated for in such a way that the predefined temperature is at least approximately maintained during the wash process and/or during the final-washing process.

10. The method as claimed in claim 1, wherein the water from the wash tank is drained into a discharge or pumped out in a pump-action extraction step after the end of a program cycle.

11. The method as claimed in claim 10, wherein draining or pump-action extraction is initiated by a user input.

12. The method as claimed in claim 1, wherein a plurality of program cycles are carried out.

13. The method as claimed in claim 1, wherein a standby step is carried out between and/or before and/or during at least one of the program cycles, wherein method steps a) to c) are carried out in the standby step in order to establish readiness for operation for a wash process.

14. The method as claimed in claim 1, wherein the wash process and the final-washing process are carried out after the end of the standby step.

15. The method as claimed in claim 1, wherein the wash tank is additionally filled with water via a fresh water inlet before the wash process.

16. The method as claimed in claim 1, wherein the water in the wash tank is additionally heated by a wash tank heater.

17. The method as claimed in claim 1, wherein a cleaning fluid, in particular a dishwashing detergent, is additionally added to the wash tank before the wash process.

18. The method as claimed in claim 1, wherein a rinse aid is additionally added to the final-washing tank and/or to the wash tank before the final-washing process is carried out.

19. The method as claimed in claim 1, wherein method steps a) to c) are carried out after the wash process is carried out, wherein the wash tank is at least partially filled with water, wherein the final-washing process is carried out with the water which is located in the wash tank.

20. The method as claimed in claim 1, wherein the wash process is carried out at a water temperature of from 50° C. to 75° C., preferably of 60° C.

21. The method as claimed in claim 1, wherein the final-washing process is carried out at a water temperature of between 50° C. and 90° C., preferably at 83° C. or at 65° C.

22. A computer program having a program code for performing the method as claimed in claim 1, the computer program being run on a computer or computer network.

23. A data storage medium or computer system in which a data structure is stored, which data structure executes the method as claimed in claim 1 after being loaded into a working and/or main memory of a computer or computer network.

24. A computer program product having program code means stored on a machine-readable storage medium, in order to carry out all the steps as claimed in claim 1 when the program is run on a computer or computer network.

25. A modulated data signal which contains instructions, which can be executed by a computer system or computer network, for executing a method as claimed in claim 1.

26. A dishwasher for commercial use, comprising:
a washing chamber having a wash tank, the dishwasher being designed to wash items, which are to be washed and are located in the washing chamber, in a wash process with a circulation operation;
a final-washing tank that is designed to subject items, which are to be washed and are located in the washing chamber, to a final-washing step; and
a controller for partially filling the final-washing tank with water, heating the water in the final-washing tank, and/or transferring the heated water to the wash tank.

27. The dishwasher as claimed in claim 26, wherein the dishwasher also comprises a connection line in order to transfer water from the final-washing tank to the wash tank.

28. The dishwasher as claimed in claim 26, wherein the dishwasher is also designed to selectively carry out the final-washing step using water from the wash tank or water from the final-washing tank.

29. The dishwasher as claimed in claim 26, wherein the dishwasher has a fresh water inlet to the wash tank.

30. The dishwasher as claimed in claim 26, wherein the dishwasher has a wash nozzle system and a final-washing nozzle system that is separate from the wash nozzle system.
